(19) United States
(12) Patent Application Publication
(10) Pub. No.: US 2026/0336744 A1
(43) Pub. Date: Oct. 29, 2026

(54) SUSPENSION UNIT FOR SADDLE-RIDE TYPE VEHICLE

(71) Applicant: SUZUKI MOTOR CORPORATION, Hamamatsu-shi (JP)

(72) Inventor: Keitaro MIYAGAWA, Hamamatsu-shi (JP)

(73) Assignee: SUZUKI MOTOR CORPORATION, Hamamatsu-shi (JP)

(21) Appl. No.: 19/655,243

(22) Filed: Apr. 22, 2026

(30) Foreign Application Priority Data
Apr. 25, 2025 (JP) 2025-073241

(51) Int. Cl. B62K 25/04; B62J 15/00; B62J 45/00

(52) U.S. Cl. CPC B62K 25/04; B62J 15/00; B62J 45/00

(57) ABSTRACT

A suspension unit for a saddle-ride type vehicle includes: a suspension body including a spring; an electronic device disposed on the suspension body; a harness configured to be connected to the electronic device; and a harness holding member formed in a cylindrical shape surrounding an outer periphery of the spring. The harness holding member includes a holding portion on an outer circumferential surface. The harness holding member configured to hold the harness.

### CROSS-REFERENCE TO RELATED APPLICATIONS

This application is based on and claims priority under 35 USC 119 from Japanese Patent Application No. 2025-073241 filed on Apr. 25, 2025, the entire content of which is incorporated herein by reference.

### TECHNICAL FIELD

The present invention relates to a suspension unit for a saddle-ride type vehicle.

### BACKGROUND ART

A saddle-ride type vehicle is equipped with a suspension unit for damping a vibration.

Patent Literature 1 discloses a motorcycle that includes a rear suspension between a main frame and a swing member. The rear suspension in Patent Literature 1 is equipped with electronic devices such as a stroke sensor for detecting an amount of extension and contraction, and an electronically controlled compression valve and an electronically controlled extension valve that can adjust damping force characteristics, and functions as an electronically controlled suspension in which the damping force is automatically controlled.

### CITATION LIST

### Patent Literature

Patent Literature 1: JP2010-167907A

Such an electronically controlled suspension is provided with harnesses for sending and receiving signals to and from a control unit and for supplying electricity to the electronic devices. When the harness is routed and spread out from the rear suspension, the harness may come into contact with surrounding parts or be pinched by a spring, so measures are taken to prevent this, for example, by holding a base end of the harness with a metal bracket. However, a large load is applied to the bracket due to resonance caused by vibration of a drive unit, vibration during driving, or swinging of the harness. To ensure durability of the bracket, it is necessary to increase a thickness of the bracket or use a high-strength material, which results in increased weight and higher costs.

### SUMMARY

The present invention has been made in view of the above-described problem, and an object thereof is to hold a harness well with a simple structure.

The present invention is a suspension unit for a saddle-ride type vehicle, includes:
a suspension body including a spring;
an electronic device disposed on the suspension body;
a harness configured to be connected to the electronic device; and
a harness holding member formed in a cylindrical shape surrounding an outer periphery of the spring.

The harness holding member includes a holding portion on an outer circumferential surface. The harness holding member configured to hold the harness.

According to the present invention, the harness can be held well with a simple structure.

### BRIEF DESCRIPTION OF DRAWINGS

FIG. 1 is a left side view illustrating a configuration of a motorcycle.

FIG. 2 is a left side view illustrating a configuration of a suspension unit and its surroundings according to a first example.

FIG. 3 is a cross-sectional view illustrating a configuration of the suspension unit.

FIG. 4 is a cross-sectional view illustrating the configuration of the suspension unit.

FIGS. 5A and 5B are diagrams illustrating the configuration of the suspension unit.

FIGS. 6A and 6B are perspective views illustrating a configuration of a harness holding member.

FIGS. 7A and 7B are diagrams illustrating a configuration of a suspension unit according to a second example.

FIG. 8 is a left side view illustrating a configuration of a suspension unit and its surroundings according to a third example.

FIG. 9 is a left side view illustrating a configuration of a suspension unit and its surroundings according to a fourth example.

### DESCRIPTION OF EMBODIMENTS

A suspension unit 40 for a saddle-ride type vehicle according to the present invention includes a suspension body 41 having a spring 54, an electronic device disposed on the suspension body 41, a harness 57 connected to the electronic device, and a harness holding member 60 formed in a cylindrical shape surrounding an outer periphery of the spring 54. The harness holding member 60 has a first holding portion 62a and a second holding portion 62b that hold the harness 57 on an outer circumferential surface. The harness holding member 60 can hold the harness 57 well with a simple structure.

### Example

A suspension unit 40 for a saddle-ride type vehicle according to the present invention and a saddle-ride type vehicle equipped with the suspension unit 40 will be described below with reference to the drawings.

### First Example

In this example, a motorcycle 1 will be used as the saddle-ride type vehicle. In each drawing, a forward direction of the motorcycle 1 is indicated by an arrow Fr, an upward direction by an arrow Up, and a left side by an arrow L, based on a direction of a rider riding the motorcycle 1.

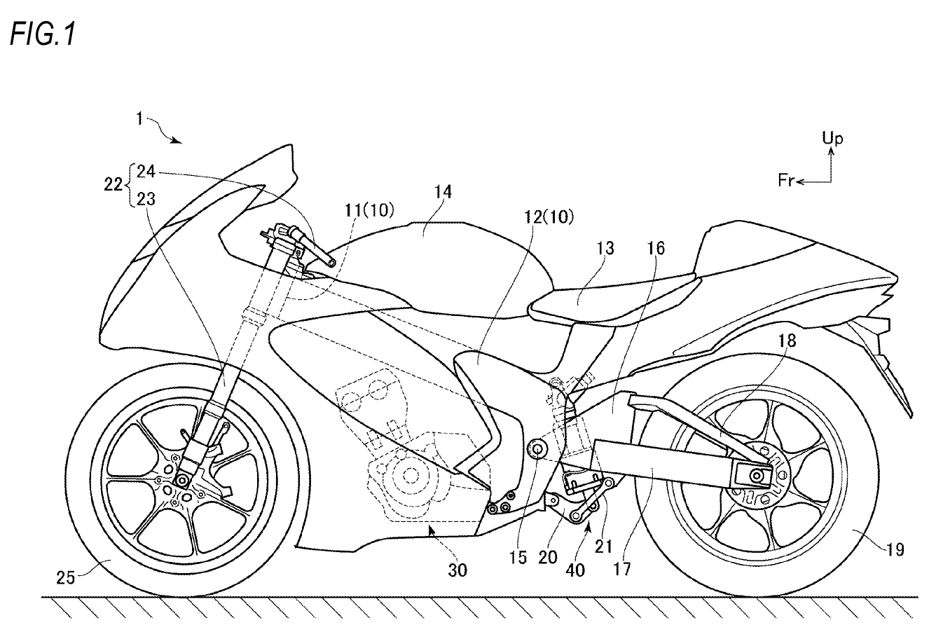

FIG. 1 is a left side view illustrating an example of a configuration of the motorcycle 1.

The motorcycle 1 has a vehicle body frame 10 made of steel or aluminum alloy that forms a vehicle body skeleton. The motorcycle 1 is configured by attaching various devices to the vehicle body frame 10.

The vehicle body frame 10 includes a steering head pipe 11, a pair of left and right main frames 12, and the like.

The steering head pipe 11 is located at a front portion of the vehicle body frame 10, and the pair of left and right main frames 12 are connected to a rear end of the steering head pipe 11. The pair of left and right main frames 12 extend obliquely downward and rearward from the rear end of the steering head pipe 11, curve, and then extend downward again. A pair of left and right seat rails (not illustrated) are disposed near rear portions of the pair of left and right main frames 12 and extend obliquely upward and rearward to support a seat 13 on which an occupant sits. A fuel tank 14 is mounted in front of the seat 13 and is supported by the pair of left and right main frames 12.

A swing member 16 is connected to the pair of left and right main frames 12 near rear lower portions thereof via a pivot shaft 15 so as to be swingable in an up-down direction. A pair of left and right lower swing arms 17 are connected to a lower rear end of the swing member 16, and a pair of left and right upper swing arms 18 are connected to an upper rear end of the swing member 16. A rear wheel 19 is rotatably supported on rear ends of the pair of left and right lower swing arms 17 and rear ends of the pair of left and right upper swing arms 18. A driven sprocket around which a chain that transmits power from an engine 30 is wound is attached to the rear wheel 19, and the rear wheel 19 is driven to rotate via the driven sprocket.

A first link member 20 and a pair of left and right second link members 21 are connected between rear lower ends of the pair of left and right main frames 12 and a rear lower end of the swing member 16. The first link member 20 is connected to rear lower ends of the pair of left and right main frames 12 and a front end of the second link member 21. The second link member 21 is connected to an approximate center of the first link member 20 in a front-rear direction and to a rear lower end of the swing member 16.

The steering head pipe 11 supports a steering device 22. The steering device 22 has a pair of left and right front forks 23 supported via a steering shaft inserted inside the steering head pipe 11, and a handlebar 24 fixed to an upper end of the steering shaft. A front wheel 25 is rotatably supported at lower ends of the pair of left and right front forks 23. When the handlebar 24 is turned left and right, the front wheel 25 turns left and right together with the front fork 23 around the steering head pipe 11.

The engine 30 serving as an internal combustion engine is mounted in an approximate center of the motorcycle 1. The engine 30 is suspended from the pair of left and right main frames 12 via a plurality of engine mounts, and functions as a rigid member of the vehicle body frame 10. Output of the engine 30 is transmitted to a drive sprocket, and from the drive sprocket to the driven sprocket via a power transmission chain, thereby driving the rear wheel 19 to rotate.

The suspension unit 40 is attached between the vehicle body frame 10 and the rear wheel 19 to absorb and damp vibrations that the rear wheel 19 receives from the road surface. The suspension unit 40 of this example has a lower end connected to a rear end of the first link member 20 and an upper end connected to rear upper ends of the pair of left and right main frames 12.

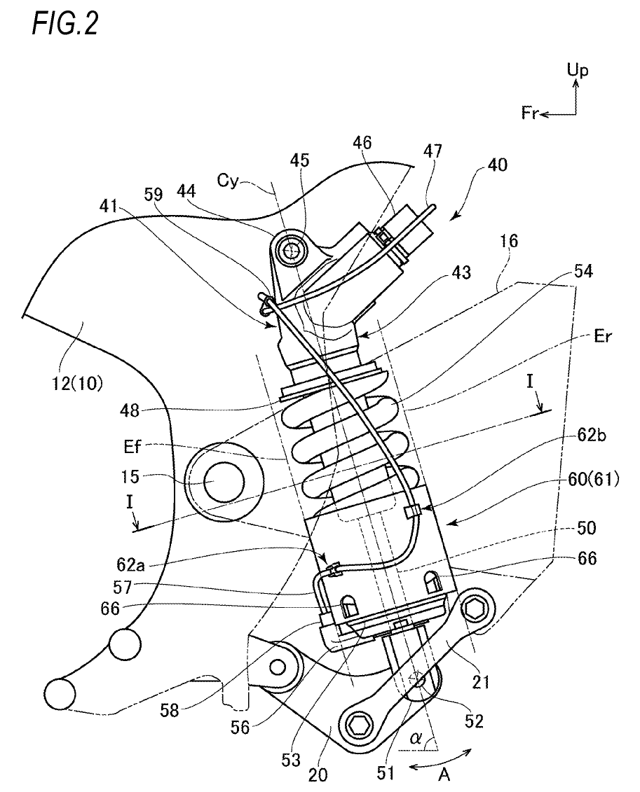

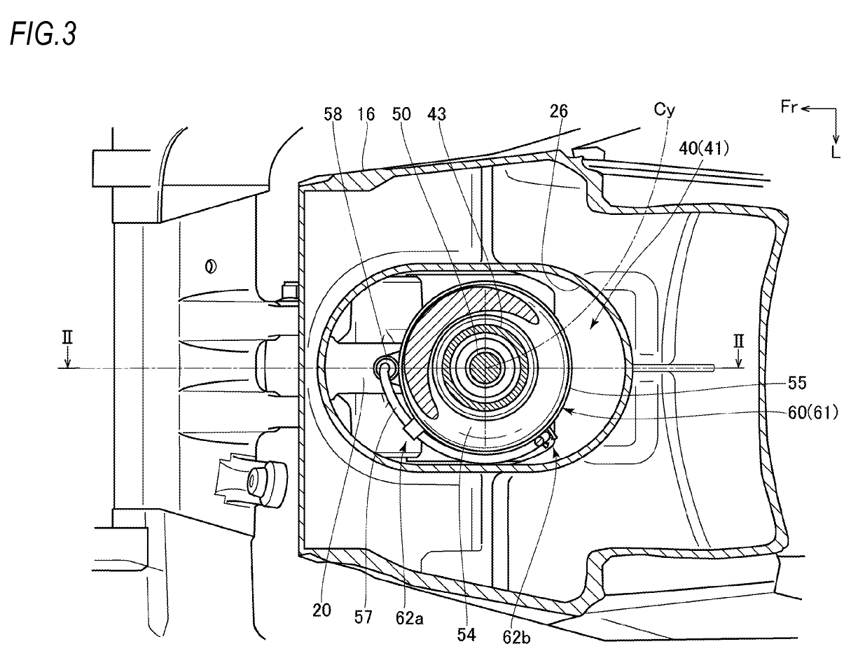

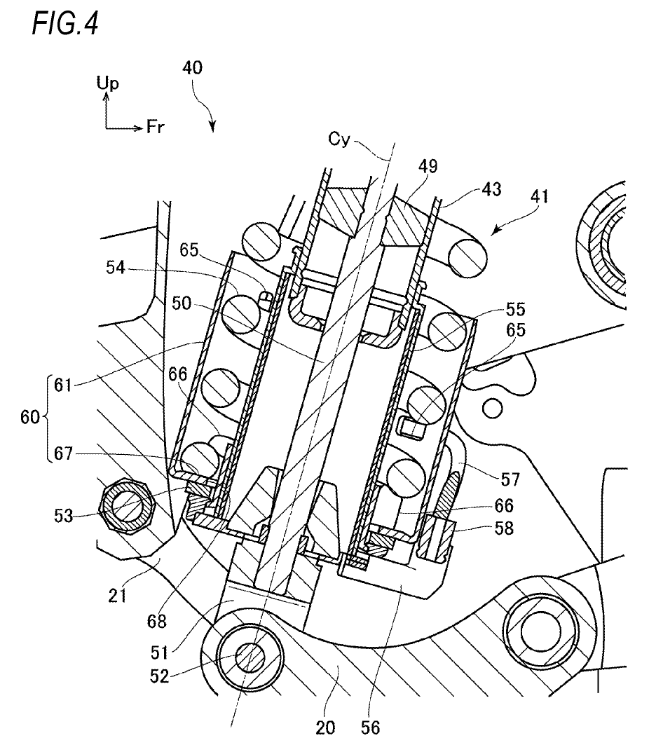

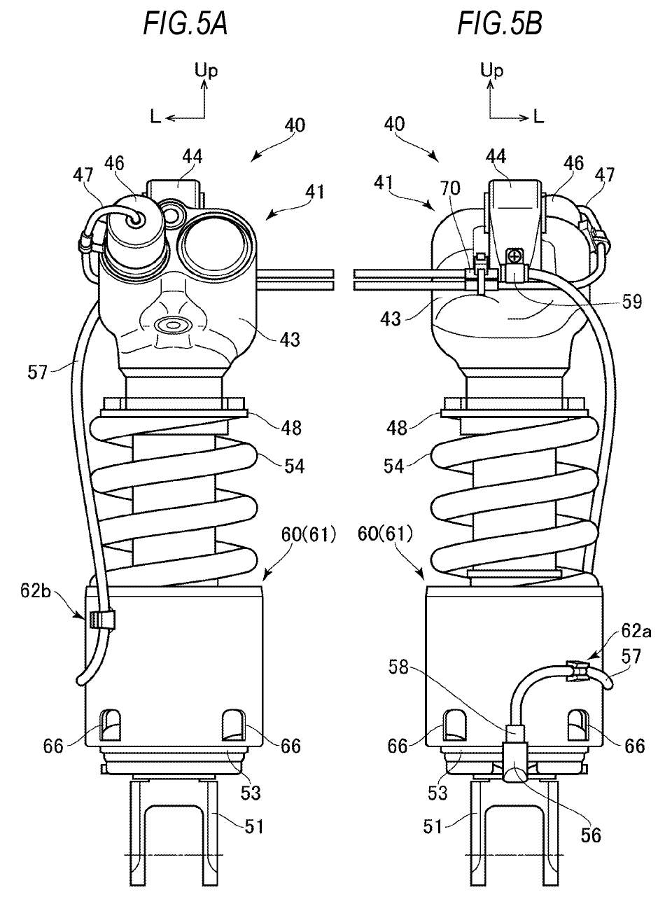

FIG. 2 is a left side view illustrating an example of a configuration of the suspension unit 40 and its surroundings. FIG. 3 is a cross-sectional view taken along a line I-I in FIG. 2 and viewed from a direction of the arrow. FIG. 4 is a cross-sectional view taken along a line II-II in FIG. 3 and viewed from a direction of the arrow. FIGS. 5A and 5B are diagrams illustrating an example of the configuration of the suspension unit 40.

The suspension unit 40 of this example is of the so-called electronically controlled type, and a control unit of the motorcycle 1 automatically controls a damping force of the suspension unit.

Specifically, the suspension unit 40 includes a suspension body 41, a stroke sensor 56 as an electronic device, a harness 57 extending outward from the stroke sensor 56, and a harness holding member 60.

The suspension body 41 is tilted forward at a moderate angle, specifically, an angle α (see FIG. 2) of a central axis Cy of a cylinder 42 with respect to the horizontal is greater than 45° and less than 90°. As illustrated in FIG. 3, the swing member 16 is formed with a hole 26 through which the suspension body 41 passes in the up-down direction so as not to interfere with the suspension body 41.

The suspension body 41 has a damper case 43 in which the cylinder 42 is formed, a piston 49 (see FIG. 4) that slides within the cylinder 42 along the central axis Cy, a rod 50 that is connected to the piston 49 and protrudes downward from the damper case 43, and a spring 54 that is arranged to surround the rod 50 and a part of the damper case 43.

The damper case 43 extends from a top to a central portion of the suspension body 41. The damper case 43 has a first mounting portion 44 attached to its upper end, and the first mounting portion 44 is attached between the pair of left and right main frames 12 via a support shaft 45 having an axis along a left-right direction. In addition, the damper case 43 has an electronically controlled valve 46 provided behind the first mounting portion 44. The electronically controlled valve 46 adjusts the damping force of the suspension body 41 based on a signal from the control unit. As illustrated in FIG. 2, the electronically controlled valve 46 is generally cylindrical and disposed so as to protrude obliquely upward and rearward from an upper rear end of the damper case 43. A harness 47 is connected to a rear end of the electronically controlled valve 46. The harness 47 supplies electricity to the electronically controlled valve 46 and transmits signals from the control unit to the electronically controlled valve 46. The harness 47 is routed from the rear end of the electronically controlled valve 46 to the left side of the damper case 43 and toward the control unit. A first spring guide 48 having a substantially disk shape is provided in a central portion of the damper case 43 in the up-down direction, and supports an upper end of the spring 54 by protruding radially beyond an outer circumferential surface of the damper case 43.

The rod 50 has a second mounting portion 51 attached to its lower end, and the second mounting portion 51 is attached to the first link member 20 via a support shaft 52 having an axis along the left-right direction. In addition, a second spring guide 53 having a substantially disk shape is provided at a position lower on the rod 50 and above the second mounting portion 51, and supports a lower end of the spring 54 by protruding radially beyond the outer circumferential surface of the rod 50.

The spring 54 is formed by being wound in a coil shape. The spring 54 is supported at its upper end by the first spring guide 48 and at its lower end by the second spring guide 53, so that it is held in an extension-contraction direction. When the spring 54 is supported by the first spring guide 48 and the second spring guide 53, a central axis of the spring 54 substantially coincides with the central axis Cy of the cylinder 42.

A cover member 55 is a cylindrical member that is disposed between the rod 50 and the spring 54. The cover member 55 is formed to have a length that extends from a lower end of the damper case 43 to the second spring guide 53.

The stroke sensor 56 detects an amount of extension and contraction of the suspension body 41, specifically, a stroke amount of the rod 50 protruding from the damper case 43. The stroke sensor 56 is located at a lower portion of the suspension unit 40 and is connected to the second spring guide 53. Therefore, when the suspension body 41 expands or contracts, the stroke sensor 56 also moves in conjunction with the rod 50 and the second spring guide 53.

The harness 57 supplies electricity to the stroke sensor 56 and transmits information about the stroke amount detected by the stroke sensor 56 to the control unit. The harness 57 is connected to the stroke sensor 56 and is routed upward from a position in front of the second spring guide 53. A harness outlet 58 is provided at a base end of the harness 57. The harness outlet 58 is located in a lower portion of the suspension unit 40 and in front of the second spring guide 53.

The harness holding member 60 is a member that holds the harness 57 so that the harness 57 does not come into contact with peripheral components of the suspension unit 40 or get pinched by the spring 54. The harness holding member 60 is located at the lower portion of the suspension unit 40 and is formed in a cylindrical shape that surrounds an outer periphery of the spring 54.

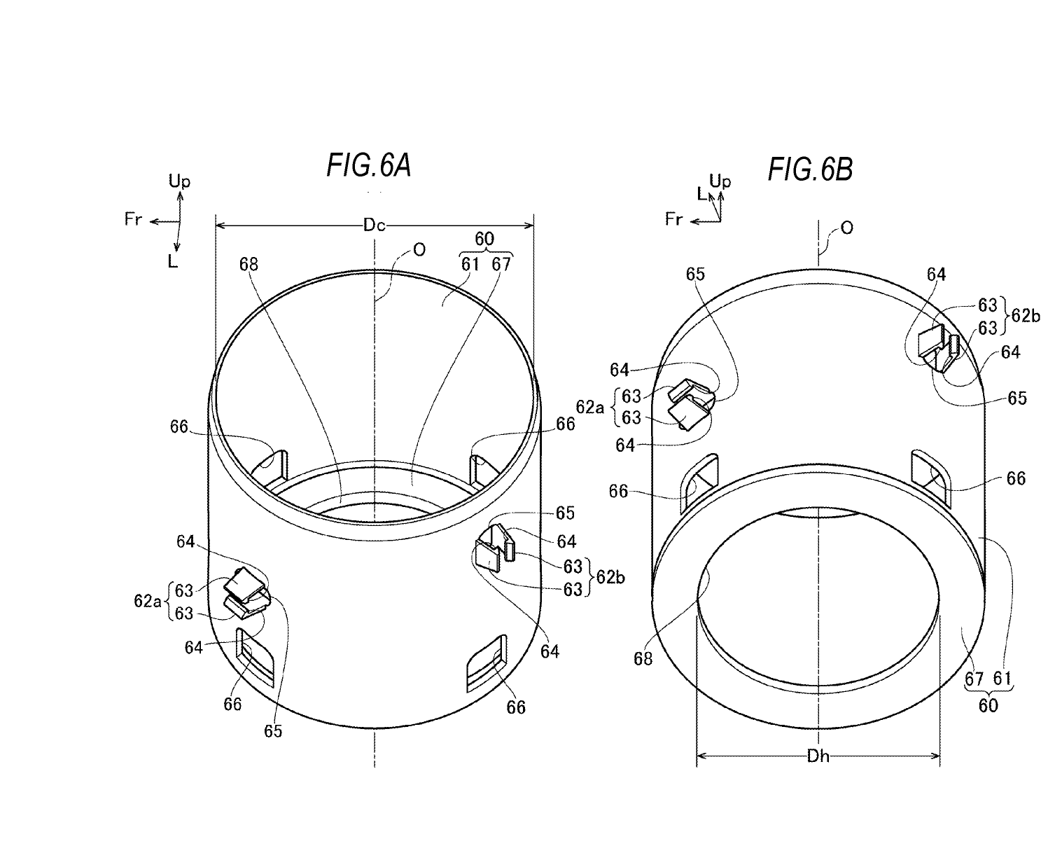

FIGS. 6A and 6B are perspective views illustrating an example of a configuration of the harness holding member 60. FIG. 6A is a perspective view of the harness holding member 60 as viewed from above, and FIG. 6B is a perspective view of the harness holding member 60 as viewed from below.

The harness holding member 60 is made of synthetic resin to reduce weight, and is integrally formed by injection molding. Specifically, the harness holding member 60 is composed of a cylindrical portion 61 and a seat portion 67 located at a lower end of the cylindrical portion 61.

First, the cylindrical portion 61 will be described.

The cylindrical portion 61 is formed in a tubular shape, specifically a cylindrical shape, that can surround the outer periphery of the spring 54. An inner diameter Dc of the cylindrical portion 61 is larger than an outer diameter of the spring 54. Further, a first holding portion 62a and a second holding portion 62b are arranged apart from each other on an outer circumferential surface of the cylindrical portion 61.

The first holding portion 62a is located approximately in the center of the cylindrical portion 61 in the up-down direction. The first holding portion 62a is the holding portion closest to a base end of the harness 57 on the path of the harness 57. On the other hand, the second holding portion 62b is located above the center of the cylindrical portion 61 in the up-down direction and close to an upper end of the cylindrical portion 61. The second holding portion 62b is the holding portion that is next closest to the base end of the harness 57 on the path of the harness 57 after the first holding portion 62a. The second holding portion 62b is the holding portion that is farthest from the base end of the harness 57 on the path of the harness 57.

The first holding portion 62a and the second holding portion 62b each protrude outward from an outer circumferential surface of the cylindrical portion 61 and are formed by a pair of protrusions 63 formed integrally with the outer circumferential surface. The pair of protrusions 63 have flexibility such that a distance between the pair of protrusions 63 increases when an external force is applied, and the distance between the pair of protrusions 63 returns to its original distance when the application of the external force is released. The first holding portion 62a and the second holding portion 62b hold the harness 57 by pinching the harness 57 between the pair of protrusions 63. Furthermore, at tips of the protrusions 63, there are formed retaining portions 64 having a claw shape that protrude in opposing directions. The retaining portion 64 is formed by an inclined surface that slopes obliquely from the tip of the protrusion 63 toward the inside of the protrusion 63, and a retaining surface that continues from the inclined surface and is approximately perpendicular to a protruding direction of the protrusion 63. The inclined surface of the retaining portion 64 has a function of making it easy to insert the harness 57 when inserting the harness 57 between the pair of protrusions 63. On the other hand, the retaining surface of the retaining portion 64 has a function of restricting the held harness 57 from unintentionally coming out from between the pair of protrusions 63. A hole 65 that communicates with the inside of the cylindrical portion 61 is formed between the pair of protrusions 63 and at the base end of the pair of protrusions 63.

The first holding portion 62a has a pair of protrusions 63 that face each other and are spaced apart from each other in the up-down direction. Therefore, when the first holding portion 62a holds the harness 57, the harness 57 is held in a direction that is a circumferential direction of the cylindrical portion 61, in other words, a circumferential direction of the spring 54. That is, the first holding portion 62a guides the harness 57 so that a guide direction of the harness 57 is along the circumferential direction of the spring 54.

When the harness holding member 60 is attached to the suspension body 41, the first holding portion 62a is biased to the left and front of the outer circumferential surface of the cylindrical portion 61 (see also FIG. 3). Here, as illustrated in FIG. 2, when a straight line (outer edge) extending from a front end of the outer circumferential surface of the cylindrical portion 61 when viewed from the side of the vehicle is Ef, the first holding portion 62a is positioned so as not to extend forward from the straight line Ef and is positioned rearward of the straight line Ef.

The second holding portion 62b has a pair of protrusions 63 that face each other and are spaced apart from each other in the front-rear (or left-right) direction. Therefore, when the second holding portion 62b holds the harness 57, the harness 57 is held in a direction that is an axial direction of the cylindrical portion 61, in other words, in an extension-contraction direction of the spring 54. That is, the second holding portion 62b guides the harness 57 so that the guide direction of the harness 57 is along the extension-contraction direction of the spring 54.

When the harness holding member 60 is attached to the suspension body 41, the second holding portion 62b is biased to the left and rearward side of the outer circumferential surface of the cylindrical portion 61 (see also FIG. 3). Here, as illustrated in FIG. 2, when a straight line (outer edge) extending from a rear end of the outer circumferential surface of the cylindrical portion 61 when viewed from the side of the vehicle is Er, the second holding portion 62b is positioned so as not to extend rearward from the straight line Er and is positioned forward of the straight line Er.

Furthermore, a plurality of communication holes 66 are formed in a lower portion of the outer circumferential surface of the cylindrical portion 61, connecting the inside and outside of the cylindrical portion 61. Water, mud, or the like that has entered the inside of the cylindrical portion 61 is discharged to the outside through the communication holes 66. In this example, the communication holes 66 are arranged so that angles between adjacent communication holes 66 about an central axis O of the cylindrical portion 61 are approximately equal, in this case, 90 degrees apart.

Next, the seat portion 67 will be described.

The seat portion 67 is located at one end of the cylindrical portion 61 in an axial direction of the central axis O, specifically at a lower end. The seat portion 67 is formed in a substantially disk shape extending from a lower end of the cylindrical portion 61 toward the central axis O of the cylindrical portion 61, and has an insertion hole 68 in a center that is generally coaxial with the central axis O of the cylindrical portion 61. An inner diameter Dh of the insertion hole 68 is smaller than an outer diameter of the spring 54, smaller than an outer diameter of the second spring guide 53, and larger than an outer diameter of the cover member 55. The seat portion 67 functions as a fixing portion for fixing the harness holding member 60 to the suspension body 41. Specifically, as illustrated in FIG. 4, the seat portion 67 is pinched between the spring 54 and the second spring guide 53, and the harness holding member 60 is fixed to the suspension body 41 in a state in which the harness holding member 60 surrounds the outer periphery of the spring 54.

A state in which the harness 57 is held by the harness holding member 60 configured as described above will be described.

When the harness holding member 60 is fixed to the suspension body 41 and the harness 57 is held by the first holding portion 62a and the second holding portion 62b, the harness 57 extends upward from a position in front of the second spring guide 53, and then curves to the left along the outer circumferential surface of the cylindrical portion 61 before being held by the first holding portion 62a. The first holding portion 62a holds the harness 57 so that a guide direction of the harness 57 is aligned with the circumferential direction of the spring 54. The harness 57 held by the first holding portion 62a further extends rearward along the outer circumferential surface of the cylindrical portion 61, then curves upward and is held by the second holding portion 62b. The second holding portion 62b holds the harness 57 so that the guide direction of the harness 57 is aligned with the extension-contraction direction of the spring 54. The harness 57 held by the second holding portion 62b extends further upward, passing an upper end of the harness holding member 60 and extending diagonally upward and forward, where the harness is held by a holding member 59 fixed to an upper and front end of the damper case 43. The harness 57 held by the holding member 59 is bound together with the harness 47 by a binding band 70, and then routed toward the control unit.

In this way, the harness holding member 60 holds the harness 57 with the first holding portion 62a and the second holding portion 62b, so that the harness 57 can be routed without spreading or bending from the suspension body 41, thereby preventing the harness 57 from coming into contact with surrounding parts or being pinched between the wires of the spring 54. Therefore, the harness 57 can be held well by the harness holding member 60.

### Second Example

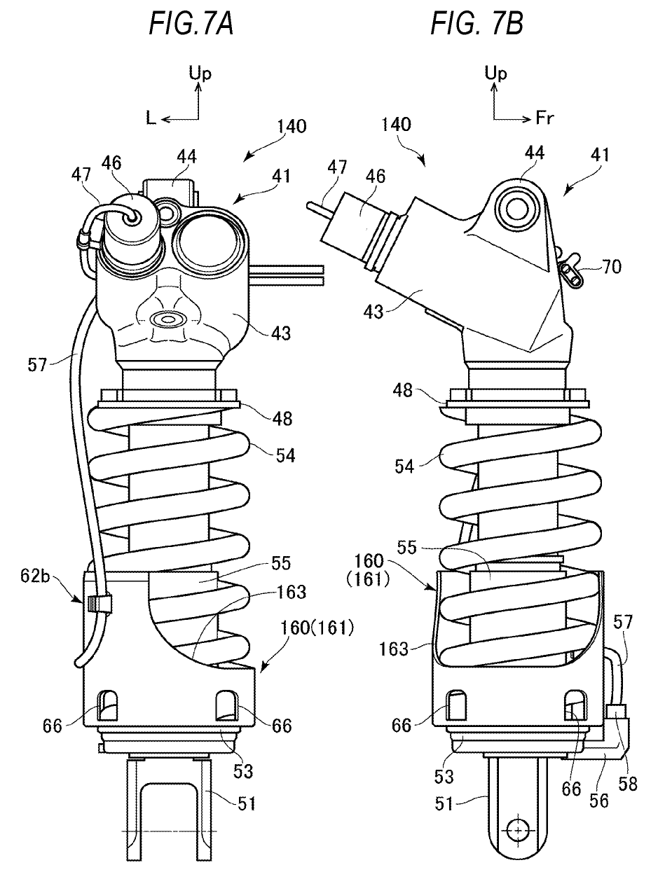

FIGS. 7A and 7B are diagrams illustrating an example of a configuration of a suspension unit 140 according to a second example.

A harness holding member 160 of the suspension unit 140 of the second example has a shape in which a portion necessary for holding the harness 57 remains and a portion not necessary for holding the harness 57 is removed. Specifically, the harness holding member 160 has a cylindrical lower portion and an upper portion with a partially cut-out cylindrical shape. The rest of the components other than the shape of the harness holding member 160 are the same as those in the first example, and the same reference numerals are used and the description thereof will be omitted.

A cylindrical portion 161 of the harness holding member 160 in this example is formed in a cylindrical shape at the bottom so as to be able to surround the outer periphery of the spring 54, and has a notch 163 formed by cutting out part of the cylindrical shape at the top. The notch 163 is located at the top and right side of the cylindrical portion 161, and the cover member 55 can be seen through the notch 163.

By forming the notch 163 in this manner, the harness holding member 160 can be made smaller and lighter. Even when the upper part of the cylindrical portion 161 is cut out, rigidity of the entire harness holding member 160 can be ensured because the lower part is cylindrical.

### Third Example

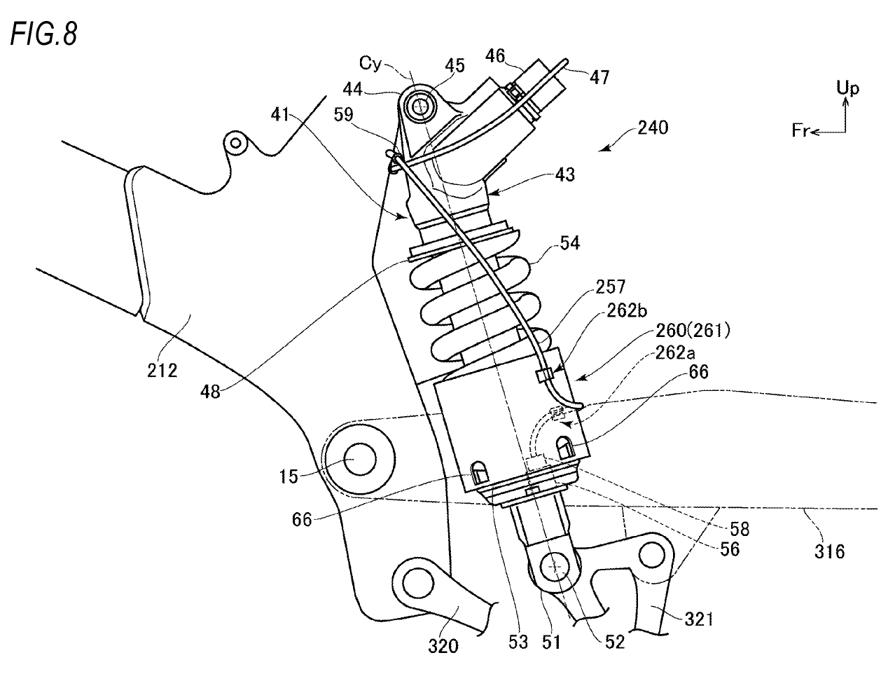

FIG. 8 is a left side view illustrating an example of a configuration of a suspension unit 240 and its surroundings according to a third example. Similar components as those in the first example are denoted by the same reference numerals and the description thereof will be omitted.

In a motorcycle of the third example, a pair of left and right swing arms 316 are connected to a pair of left and right main frames 212 near rear lower portions thereof via the pivot shaft 15 so as to be swingable up and down. The rear wheel 19 is rotatably supported at rear ends of the pair of left and right swing arms 316. Furthermore, a first link member 320 and a second link member 321 are connected between a rear lower ends of the pair of left and right main frames 212 and a lower ends of the pair of left and right swing arms 316. In the suspension unit 240 of this example, the second mounting portion 51 is attached to the second link member 321 via the support shaft 52.

The suspension unit 240 of this example includes the suspension body 41, the stroke sensor 56 as an electronic device, a harness 257 extending outward from the stroke sensor 56, and a harness holding member 260. The harness 257 is connected to the stroke sensor 56 and is routed upward from a position on the right side of the second spring guide 53.

The harness holding member 260 has a first holding portion 262a and a second holding portion 262b arranged apart from each other on the outer circumferential surface. The first holding portion 262a and the second holding portion 262b are disposed rearward of the central axis Cy of the cylinder 42. Specifically, the first holding portion 262a is located approximately in the center of the cylindrical portion 161 in the up-down direction, and is biased toward the right and rear of the outer circumferential surface of the cylindrical portion 161. On the other hand, the second holding portion 262b is located above the center of the cylindrical portion 161 in the up-down direction, close to the upper end of the cylindrical portion 161, and is biased to the left and rear of the outer circumferential surface of the cylindrical portion 161.

Therefore, the harness 257 held by the harness holding member 260 extends upward from a position on the right side of the second spring guide 53, and then curves backward along the outer circumferential surface of the cylindrical portion 161 before being held by the first holding portion 262a. The harness 257 held by the first holding portion 262a further extends leftward along the outer circumferential surface of the cylindrical portion 261, then curves upward and is held by the second holding portion 262b. The harness 257 held by the second holding portion 262b extends further upward, passing the upper end of the harness holding member 260, and extends diagonally upward and forward, where the harness is held by the holding member 59 fixed to the upper and front end of the damper case 43.

In this way, by arranging the first holding portion 262a and the second holding portion 262b rearward of the central axis Cy of the cylinder 42, the path of the harness 257 can be concentrated behind the spring 54. Furthermore, by appropriately changing positions at which the first holding portion 262a and the second holding portion 262b are disposed, the path of the harness 257 can be changed. Furthermore, the cylindrical portion 261 of the harness holding member 260 can protect the suspension body 41 from splashes of water, mud, or the like, and chipping.

### Fourth Example

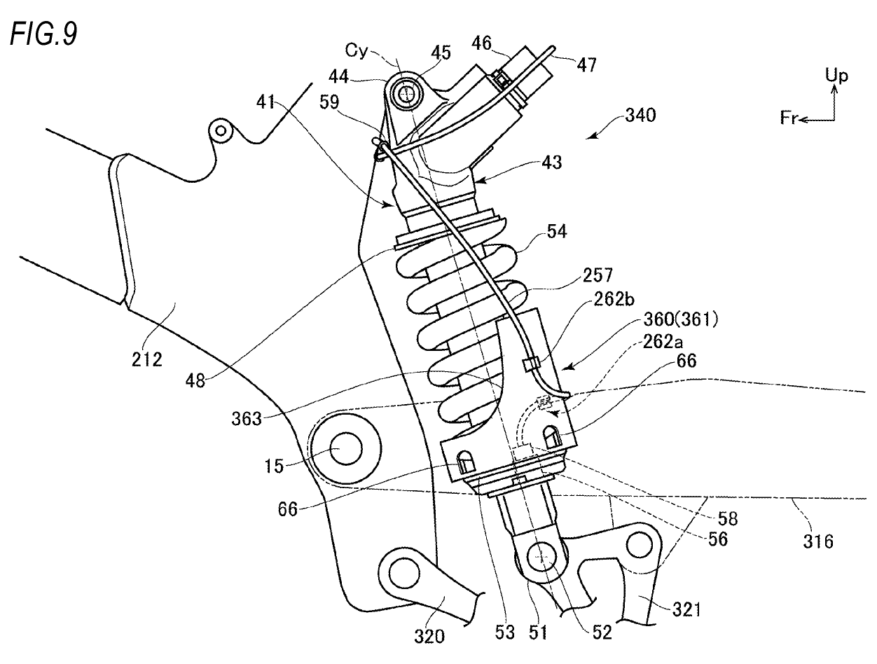

FIG. 9 is a left side view illustrating an example of a configuration of a suspension unit 340 and its surroundings according to a fourth example.

A harness holding member 360 of the suspension unit 340 of the fourth example has a shape in which a rear portion of the harness holding member 260 of the third example that is necessary for holding the harness 257 remains, and a front portion that is not necessary for holding the harness 257 is removed. The rest of the components other than the shape of the harness holding member 360 are the same as those in the third example, and the same reference numerals are used and the description thereof will be omitted.

The cylindrical portion 361 of the harness holding member 360 in this example has a cylindrical shape at the bottom that can surround the outer periphery of the spring 54, and a notch 363 formed by cutting out part of the cylindrical shape at the top. The notch 363 is located at the top and front of the cylindrical portion 361. Therefore, the outer circumferential surface of the cylindrical portion 361 is mainly disposed rearward of the central axis Cy of the cylinder 42, and can function as a mudguard against the rear of the vehicle.

By forming the notch 363 in this manner, the harness holding member 360 can be made smaller and lighter. Furthermore, since the outer circumferential surface of the cylindrical portion 361 is positioned mainly rearward of the central axis Cy of the cylinder 42, the suspension body 41 can be protected from splashes of water, mud, or the like from the rear of the vehicle and chipping.

As described above, the harness holding member 60, 160, 260, 360 of this example has the first holding portion 62a, 262a and the second holding portions 62b, 262b that hold the harness 57, 257 on its outer circumferential surface, and therefore can hold the harness 57, 257 well without the harness 57, 257 being pinched between the wires of the spring 54. Furthermore, the harness holding member 60, 160, 260, 360 has a simple structure due to its cylindrical shape, while vibration is less likely to occur than with a metal bracket, ensuring high rigidity. Furthermore, the harness holding member 60, 160, 260, 360 is cylindrical and surrounds the outer periphery of the spring 54, and therefore can protect the suspension body 41 from splashes of water, mud, or the like, and chipping.

In addition, the first holding portion 62a, 262a and the second holding portion 62b, 262b have a pair of protrusions 63 formed integrally on the outer circumferential surface of the harness holding member 60, 160, 260, 360, and hold the harness 57, 257 by pinching the harness 57, 257 between the pair of protrusions 63. Therefore, the harnesses 57, 257 can be held without using any additional parts.

In addition, the harness holding member 60, 160, 260, 360 has the seat portion 67 at one end in the axial direction, and the seat portion 67 is pinched between the spring 54 and the second spring guide 53, thereby being fixed in a state in which the harness holding member 60, 160, 260, 360 surrounds the outer periphery of the spring 54. Therefore, the harness holding member 60, 160, 260, 360 is constantly pressed against the second spring guide 53 by the spring 54, and therefore the harness holding member 60, 160, 260, 360 can be fixed in a state in which the harness holding member 60, 160, 260, 360 surround the outer periphery of the spring 54 without rattling.

The harness holding member 60, 160, 260, 360 also has the communication hole 66 at the lower part of the outer circumferential surface of the cylindrical portion 61, 161, 261, 361, which connects the inside and outside of the cylindrical portion 61, 161, 261, 361. Therefore, even when water, mud, or the like splashes onto the suspension unit 40, 140, 240, 340 and enters the inside of the harness holding member 60, 160, 260, 360, the water, mud, or the like can be discharged through the communication hole 66.

In addition, in the harness holding member 60, 160, 260, 360, the first holding portion 62a, 262a and the second holding portion 62b, 262b are arranged separately on the outer circumferential surface of the cylindrical portion 61, 161, 261, 361. Therefore, the harness 57, 257 can be held more securely, and the angle at which the harness 57, 257 is taken out can be easily changed.

The first holding portion 62a, 262a is formed so that the guide direction of the harness 57, 257 is along the circumferential direction of the spring 54, and the second holding portion 62b, 262b is formed so that the guide direction of the harness 57, 257 is along the extension-contraction direction of the spring 54. In this way, by arranging the first holding portion 62a, 262a and the second holding portion 62b, 262b so that their guide directions intersect, the harness 57, 257 is less likely to shift, and bending away from the outer circumferential surface of the cylindrical portion 61 is less likely to occur between the first holding portion 62a, 262a and the second holding portion 62b, 262b, making it easier to maintain the harness 57, 257 in a state that follows the outer circumferential surface.

Further, on the path of the harness 57, 257, the second holding portion 62b, 262b that is farthest from the base end of the harness 57, 257 is formed so that the guide direction of the harness 57, 257 is along the extension-contraction direction of the spring 54. The second holding portion 62b, 262b is positioned so as not to protrude from the straight line (outer edge) Er extending from the rear end of the outer circumferential surface of the cylindrical portion 61, 161, 261, 361 when viewed from the axial direction of the support shaft 45, 52 that supports the suspension unit 40, 140, 240, 340. Therefore, the position of the second holding portion 62b, 262b can be contained inside the outer circumferential surface of the cylindrical portion 61, and the harness 57, 257 can be prevented from flying out in a swinging direction (see an arrow A in FIG. 2) of the suspension unit 40, 140, 240, 340, thereby preventing the harness 57, 257 from being damaged.

Furthermore, since the outer circumferential surface of the cylindrical portion 361, the first holding portion 262a, and the second holding portion 262b of the harness holding member 360 are positioned rearward of the central axis Cy of the cylinder 42, it is possible to prevent water, mud, or the like from adhering to the spring 54 and to protect the suspension body 41 from chipping.

Furthermore, the harness holding member 360 has a shape in which the rear portion necessary as a mudguard is left and the unnecessary front portion is removed, thereby enabling reduction in size and weight.

The above describes examples of the present invention, but the present invention is not limited to the above-described examples, and modifications and the like are possible within the scope of the present invention, and some configurations of the examples may be combined with other examples.

In the above-described examples, the saddle-ride type vehicle is the motorcycle 1, but it may be another saddle-ride type vehicle such as a three-wheeled motor vehicle or an ATV.

In the above-described examples, the electronic device is the stroke sensor 56, but the present invention is not limited thereto and may be another sensor or another electronic device.

In the above-described examples, the harness holding member 60, 160, 260, 360 is made of synthetic resin, but the present invention is not limited thereto. For example, the harness holding member 60, 160, 260, 360 may be made of metal, such as a metal plate formed into a cylindrical shape. In this case, the seat portion 67 may be formed integrally or may be formed separately and then joined by post-processing. Furthermore, the harness 57, 257 may be held by providing a binding band or a clip in a hole formed in the outer circumferential surface of the cylindrical portion of the metal harness holding member.

In the above-described examples, the harness holding member 60, 160, 260, 360 is described as having the first holding portion 62a, 262a and the second holding portion 62b, 262b, but the present invention is not limited to this case and the harness holding member may have only one holding portion, or may have three or more holding portions.

In the above-described examples, the harness holding member 60, 160, 260, 360 is described as being fixed to the suspension body 41 by pinching the seat portion 67 between the spring 54 and the second spring guide 53, but the present invention is not limited to this case, and the harness holding member 60, 160, 260, 360 may also be fixed to the suspension body 41 using a fixing member.

1. A suspension unit for a saddle-ride type vehicle, comprising:
a suspension body including a spring;
an electronic device disposed on the suspension body;
a harness configured to be connected to the electronic device; and
a harness holding member formed in a cylindrical shape surrounding an outer periphery of the spring, wherein
the harness holding member includes a holding portion on an outer circumferential surface, the harness holding member configured to hold the harness.

2. The suspension unit for a saddle-ride type vehicle according to claim 1, wherein
the holding portion includes a pair of protrusions that protrude outward from the outer circumferential surface of the harness holding member and are integrally formed on the outer circumferential surface, and
the pair of protrusions configured to hold the harness by pinching the harness between the pair of protrusions.

3. The suspension unit for a saddle-ride type vehicle according to claim 1, further comprising a spring guide configured to hold the spring in an extension-contraction direction, wherein
the harness holding member includes a seat portion at one end in an axial direction, and the seat portion is pinched between the spring and the spring guide so that the harness holding member is fixed in a state of surrounding the outer periphery of the spring.

4. The suspension unit for a saddle-ride type vehicle according to claim 1, wherein
when the suspension unit is mounted on a vehicle,
a base end of the harness and the harness holding member are located in a lower portion of the suspension unit, and
the harness holding member includes a communication hole in a lower portion of the outer circumferential surface, the communication hole communicating inside and outside of the harness holding member.

5. The suspension unit for a saddle-ride type vehicle according to claim 1, wherein the harness holding member includes a plurality of the holding portions arranged at intervals on the outer circumferential surface of the harness holding member.

6. The suspension unit for a saddle-ride type vehicle according to claim 5, wherein
among the plurality of holding portions, the holding portion closest to the base end of the harness on a path of the harness is defined as a first holding portion, and the holding portion next closest to the base end of the harness is defined as a second holding portion,
the first holding portion is formed so that a guide direction of the harness is along a circumferential direction of the spring, and
the second holding portion is formed so that the guide direction of the harness is along an extension-contraction direction of the spring.

7. The suspension unit for a saddle-ride type vehicle according to claim 5, wherein
among the plurality of holding portions, the holding portion farthest from the base end of the harness on a path of the harness is formed such that a guide direction of the harness is along an extension-contraction direction of the spring, and
the farthest holding portion is positioned so as not to protrude from an outer edge of the outer circumferential surface when viewed in an axial direction of a support shaft that supports the suspension unit.

8. The suspension unit for a saddle-ride type vehicle according to claim 1, wherein
when the suspension unit is mounted on a vehicle,
the outer circumferential surface and the holding portion of the harness holding member are disposed rearward of a central axis of the spring.

9. The suspension unit for a saddle-ride type vehicle according to claim 8, wherein the harness holding member has a shape in which a rear portion required as a mudguard remains and a front portion not required is removed.
